(19) United States
(12) Patent Application Publication
(10) Pub. No.: US 2026/0320050 A1
(43) Pub. Date: Oct. 15, 2026

(54) LARGE LANGUAGE MODEL-BASED SYSTEMS AND METHODS FOR AUTOMATING COMPLEX QUERY PROCESSING IN INFRASTRUCTURE GRAPH DATABASES

(71) Applicant: JPMORGAN CHASE BANK, N.A., New York, NY (US)

(72) Inventors: Konstantinos GOURGOULIAS, London (GB); Rozie Tereza YEGHIAZARIAN, Jersey City, NJ (US); William Joel GUEST, Conroe, TX (US); Senad IBRAIMOSKI, London (GB); Bruce PEIKON, East Northport, NY (US); Najah GHALYAN, Wayne, NJ (US); Sean MORAN, London (GB)

(21) Appl. No.: 19/222,369

(22) Filed: May 29, 2025

(30) Foreign Application Priority Data
Apr. 10, 2025 (GR) 20250100279

(51) Int. Cl. G06F 16/2455; G06F 16/22; G06F 16/25

(52) U.S. Cl. CPC G06F 16/2455; G06F 16/2264; G06F 16/258

(57) ABSTRACT

A method may include: (1) receiving, by a computer program and from a user electronic device, a user input comprising a user request to a graph database; (2) interpreting, by the computer program and using a large language model (LLM), the user request in context of the graph database; (3) identifying, by the computer program and using the LLM, a relevant graph query for the interpreted user request; (4) executing, by the computer program, the relevant graph query on the graph database; (5) transforming, by the computer program, raw output from the graph database into tabular data; (6) generating, by the computer program and using the LLM, a summary of the tabular data; and (7) returning, by the computer program, the summary to the user electronic device.

### RELATED APPLICATIONS

This application claims priority to, and the benefit of, Greek Patent Application No. 20250100279, filed Apr. 10, 2025, the disclosure of which is hereby incorporated, by reference, in its entirety.

### BACKGROUND OF THE INVENTION

### 1. Field of the Invention Embodiments relate to large language model-based systems and methods for automating complex query processing in infrastructure graph databases.

### 2. Description of the Related Art

Large organizations maintain infrastructure graphs that contain information about their information technology networks. These are often stored in labeled-property graph databases. Engineers and subject-matter experts (SMEs) can query the infrastructure graphs using strategically written graph queries. At times, only a subset of data is modeled in the graph and the remainder distributed between other databases with their own respective query languages. Such queries, however, are complex and often require logging on to multiple platforms to visually examine operational states, then other platforms to locate active incidents or changes, and so on.

### SUMMARY OF THE INVENTION

Large language model-based systems and methods for automating complex query processing in infrastructure graph databases are disclosed. In one embodiment, a method may include: (1) receiving, by a computer program and from a user electronic device, a user input comprising a user request to a graph database; (2) interpreting, by the computer program and using a large language model (LLM), the user request in context of the graph database; (3) identifying, by the computer program and using the LLM, a relevant graph query for the interpreted user request; (4) executing, by the computer program, the relevant graph query on the graph database; (5) transforming, by the computer program, raw output from the graph database into tabular data; (6) generating, by the computer program and using the LLM, a summary of the tabular data; and (7) returning, by the computer program, the summary to the user electronic device.

In one embodiment, the method may also include: determining, by the computer program, that the user request may include a complex request; and splitting, by the computer program, the user request into a plurality of simple requests.

In one embodiment, the computer program splits the user request into the plurality of simple requests by: prompting the LLM with the user request and a list of available graph queries to split the user request into the plurality of simple requests.

In one embodiment, the method may also include: formatting, by the computer program, the user request to a formatting standard.

In one embodiment, the step of interpreting the user request in context of the graph database may include: prompting the LLM to interpret the user request to replace concepts in the user request with terminology that may be specific to that used by the graph database.

In one embodiment, the step of identifying, the relevant graph query for the interpreted user request may include: prompting, by the computer program, the LLM with the interpreted user request, a list of allowed queries, and expected parameters for those queries to return the relevant query for the interpreted user request.

In one embodiment, the step of transforming the raw output from the graph database into tabular data may include: executing, by the computer program, code generated by the LLM to convert a subset of the raw output into tabular data.

In one embodiment, the code may include table data manipulation functions.

In one embodiment, the method may also include prompting, by the computer program, the LLM to infer column names for the tabular data from the raw output.

In one embodiment, the step of generating a summary of the tabular data may include: prompting, by the computer program, the LLM for the summary by providing the LLM with the tabular data and the user input.

According to another embodiment, a non-transitory computer readable storage medium may include instructions stored thereon, which when read and executed by one or more computer processors, cause the one or more computer processors to perform steps comprising: receiving, from a user electronic device, a user input comprising a user request to a graph database; interpreting, using a large language model (LLM), the user request in context of the graph database; identifying, using the LLM, a relevant graph query for the interpreted user request; executing the relevant graph query on the graph database; transforming raw output from the graph database into tabular data; generating, using the LLM, a summary of the tabular data; and returning the summary to the user electronic device.

In one embodiment, the non-transitory computer readable storage medium may also include instructions stored thereon, which when read and executed by the one or more computer processors, cause the one or more computer processors to perform steps comprising: determining that the user request may include a complex request; and splitting the user request into a plurality of simple requests.

In one embodiment, the step of splitting the user request into a plurality of simple requests may include: prompting the LLM with the user request and a list of available graph queries to split the user request into the plurality of simple requests.

In one embodiment, the non-transitory computer readable storage medium may also include instructions stored thereon, which when read and executed by the one or more computer processors, cause the one or more computer processors to perform steps comprising: formatting the user request to a formatting standard.

In one embodiment, the step of interpreting the user request in context of the graph database may include: prompting the LLM to interpret the user request to replace concepts in the user request with terminology that may be specific to that used by the graph database.

In one embodiment, the step of identifying, the relevant graph query for the interpreted user request may include: prompting the LLM with the interpreted user request, a list of allowed queries, and expected parameters for those queries to return the relevant query for the interpreted user request.

In one embodiment, the step of transforming the raw output from the graph database into tabular data may include: executing code generated by the LLM to convert a subset of the raw output into tabular data.

In one embodiment, the code may include table data manipulation functions.

In one embodiment, the non-transitory computer readable storage medium may also include instructions stored thereon, which when read and executed by the one or more computer processors, cause the one or more computer processors to perform steps comprising: prompting the LLM to infer column names for the tabular data from the raw output.

In one embodiment, the step of generating a summary of the tabular data may include: prompting the LLM for the summary by providing the LLM with a subset of the tabular data and the user input.

### BRIEF DESCRIPTION OF THE DRAWINGS

For a more complete understanding of the present invention, the objects and advantages thereof, reference is now made to the following descriptions taken in connection with the accompanying drawings in which:

FIG. 1 illustrates a large language model-based system for automating complex query processing in infrastructure graph databases according to an embodiment;

FIG. 2 depicts a large language model-based method for automating complex query processing in infrastructure graph databases according to an embodiment;

FIG. 3 depicts an exemplary computing system for implementing aspects of the present disclosure.

### DETAILED DESCRIPTION OF PREFERRED EMBODIMENTS

Embodiments relate to large language model-based systems and methods for automating complex query processing in infrastructure graph databases according to an embodiment.

Embodiments may abstract away the technical complexity of interacting with dynamic infrastructure data stored in a graph database to automate otherwise tedious, manual processes and speed up time to major incident (MINC) resolution.

The agent has a dedicated connection to the graph database and related systems can use this connection to always remain up-to-date on the latest graph queries available to it.

Embodiments may provide the following technical advantages. First, a user interaction history may be used to optimize future interactions, e.g., caching data, etc.

Next, because the agent always follows the same steps, the computer program may estimate how much time it will take to get an answer before a request is made to the agent.

Embodiments do not depend on the contents of the graph database, so it can be reused for other instances.

In embodiments, an AI Agent may be used on top of a graph database depicting an infrastructure digital twin, abstracting away the complexity of the data, allowing network engineers to interact with the data using natural language questions. This agent can significantly expedite major incident response by automating extensive manual steps and analysis of the incident landscape. It may also automate thorough reporting on the health of infrastructure components.

The AI agent may include extendable tools that can be adapted to future use-cases without impacting the main agent design and deployment.

Once a tool is extended, the AI agent can immediately make use of the new functionality.

Embodiments do not expose the AI agent to a lot of infrastructure information per call, thereby reducing latency and the likelihood of hallucinations.

Embodiments may provide modularity of data manipulations. For example, data manipulation capabilities may be separated into a separate library.

In embodiments, if query does not yet exist in the graph for an incoming user request, a feedback loop may use the LLM to draft a sample query that may be able to answer the question. If the query is complex, it will then be reviewed by SMEs before being added to the pool of graph queries available to the agent for future use.

In one embodiment, all queries may be reviewed by SMEs to ensure a human-in-the-loop

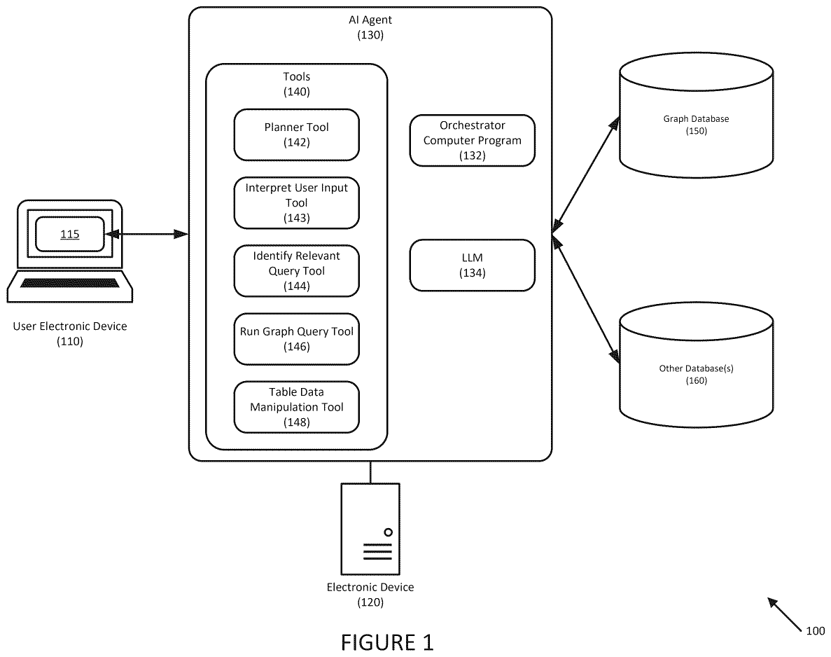

Referring to FIG. 1, a large language model-based system for automating complex query processing in infrastructure graph databases is disclosed according to an embodiment. System 100 may include user electronic device 110, such as a computer (e.g., a workstation, a desktop, a laptop, a notebook, a tablet, etc.), a smart device (e.g., smart phone, smart watch, etc.), an Internet of Things (IOT) appliance, etc. User electronic device 110 may execute user computer program 115, such as a program, an application, a browser, etc.

User computer program 115 may communicate with AI agent 130, which may be a platform executed by electronic device 120. Electronic device 120 may be a server (e.g., cloud-based and/or physical), a computer, etc.

In one embodiment, user electronic device 110 and electronic device 120 may be the same electronic device.

AI agent 130 may include a plurality of software modules, including tools 140, orchestrator computer program 132, and large language model (LLM) 134. Orchestrator computer program 132 may control the operation and the inputs received by tools 140.

LLM 134 may be a deep learning model, such as a generative pre-trained transformer model.

Tools 140 may include software programs or scripts that interface with large language model 134 and graph database 150, such as planner tool 142, identify relevant query tool 144, run graph query tool 146, and table data manipulation tool 148. Planner tool 142 may receive a user input from user computer program 115, and may prompt the LLM to break a complex user request into simpler parts for processing. Planner tool 142 may prompt the LLM to ground the user request in the context of the graph by, for example, adding specific context to the request.

For example, planner tool 142 may have knowledge of all queries that can be made to graph database 150 as well as the possibility of using table data manipulation tool 148 on data received from graph database 150. Planner tool 142 may receive the user input and may return it as is (i.e., if it is already a simple request) or may break it down into simple parts.

Interpret user input tool 143 may ground the user input in context from the graph database, replacing concepts in the input text with graph-specific terminology. For example, the LLM may receive the original user request and knowledge about the concepts in the graph database, and may be prompted to transform the user request to one that is grounded in the context of the database. The LLM may then rewrite the user input with this context and return the rewritten user input to the computer program.

Identify relevant query tool 144 may receive a user request and the list of available queries and may identify the most relevant query that will answer the user request.

Run graph query tool 146 may run the graph query from identify relevant query tool 144 on graph database 150. It may be a single call to graph database 150, and it may provide the data to table data manipulation tool 148.

Table data manipulation tool 148 may receive a table of data from run graph query tool 146 and may receive the user request as input. Then it generates and executes code to process that table, e.g., filter it, compute statistics, etc. In one embodiment, table data manipulation tool 148 process the data retrieved from graph database 150 according to the user request.

Examples of table data manipulation tools are in the pandas library data frame operations in Python.

For example, if the user request is “which device has property X?”, then table data manipulation tool 148 would run a filtering operation on the table of devices and properties that were retrieved from graph database 150.

System 100 may further include databases, such as graph database 150 and other databases 160. Graph database 150 may store any suitable graph. Other databases 160 may be databases that may store tabular data that users can query with standard SQL. Other databases 160 may store additional information about the nodes of graph database 150. For example, if graph database 150 store information about devices, other databases 160 may store properties about those devices that do not change very often.

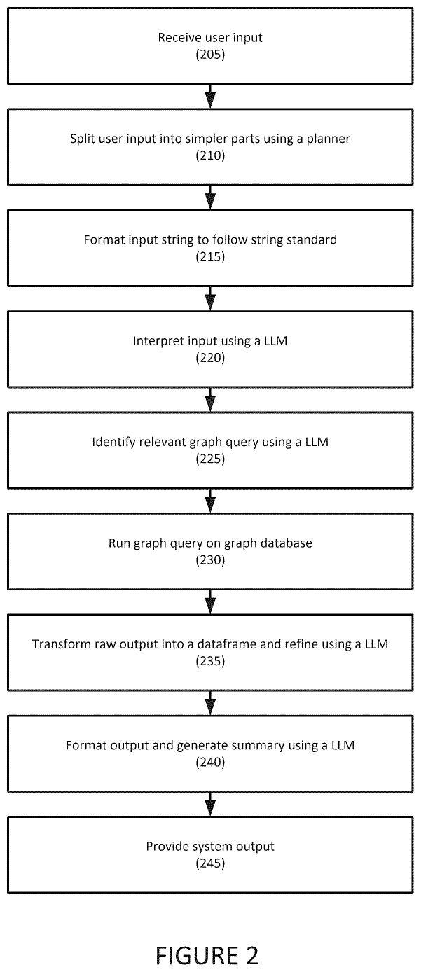

Referring to FIG. 2, a large language model-based method for automating complex query processing in infrastructure graph databases is disclosed according to an embodiment.

In step 205, a computer program, such as an orchestrator, may receive a user input including a user request.

As necessary, in step 210, using a planner tool, the computer program may split a user input into simpler parts. A simple request is one that can be resolved with a single data transfer from the graph database. A complex request is one that requires multiple data requests. If the user input is complex the computer program may use a planner tool to prompt a LLM to break the user input into simple requests, such as single requests.

The LLM may be prompted with the user input and the available graph queries, and may be asked to classify the user input as simple or not. If the user input is not simple, the LLM may be asked to split the user input into a list of simple ones.

Once a request is split into simple requests, they may be processed in series.

In step 215, the computer program may format the user request (e.g., an input string) to follow a string standard, such as an input string formatting standard. An example of such formatting is setting all characters in the user request to lowercase. This may be performed by a software function.

In step 220, the computer program may interpret the user input using an interpret input tool to query the LLM to interpret the query in context of the graph being queried.

The interpretation may ground the user input in context from the graph database, replacing concepts in the input text with graph-specific terminology. Taking this approach keeps the agent versatile, adapting diverse user inputs and translating them to familiar, standard vocabulary for the following tools.

For example, the LLM may receive the original user request and knowledge about the concepts in the graph database, and may be prompted to transform the user request to one that is grounded in the context of the database.

The LLM may then rewrite the user input with this context and return the rewritten user input to the computer program.

In step 225, the computer program may identify relevant graph query using an identity relevant query tool and the graph data source to identify the graph query out of a predetermined set of graph queries to user.

For example, using the output of the interpret input tool, the computer program may prompt the LLM to identify the most relevant query (e.g., a request for specific information from the graph database, such as a SQL query) to use to respond to the request. The LLM may need to have knowledge of the queries that it is allowed to execute on the graph database, as well as the expected parameters required for those queries.

In step 230, the computer program may run the identified graph query on the graph database using, for example, a run graph query tool. The run graph query tool may receive a raw output from the graph database as a result of the query.

In step 235, the computer program may transform the raw output of the graph database using a table data manipulation tool. For example, using the table data manipulation tool, the raw output of the graph database may be transformed into tabular data (e.g., a table with rows and columns). An example of such a structure is a “dataframe” data structure in Python that represents tabular data in Python.

The LLM inspects a subset of the tabular data alongside the user question and writes Python code that use table data manipulation to answer the user question.

An example process using a table data manipulation tool is as follows. First, when data is received from the graph database, it is not in tabular format. Instead, the data may be in a JSON-like format that has small differences depending on the query that was used. Conversion to the tabular format requires to be able to figure out what is the right Python code to run to do the conversion.

In some instances, the JSON-like format may be converted into a table simply, but the table would have no meaningful column names. In that case, the computer program may query the LLM to infer the column names from a small subset of the table data.

Next, as small subset of the new table is passed to the LLM with one or more table data manipulation tools that the LLM is allowed to use. The LLM may return code that may be run to get closer to the answer to the user request. A small subset is enough for this step (and often necessary as the tables can be much larger than the text an LLM can process).

To run the code in a safe manner, the code may be checked to ensure that it only calls the allowed table data manipulation functions. If not, the computer program may re-query the LLM to get a better set of commands.

This setup ensures that the step is fast (e.g., as only 2-3 rows of data are shared with the LLM) and secure (e.g., the LLM can only use the data manipulation functions the developers allow).

The computer program may then execute the code. The execution results in a better formatted table that only contains the data required to answer the question. For example, instead of asking the LLM to work with 10,000 rows and 100 columns, the table may be filtered to 5 rows and 3 columns. This allows the LLM to focus on what is relevant.

In step 240, the computer program may receive the table, may format the output, and may generate a summary using the LLM. For example, the LLM may be prompted with the filtered and processed table and the original question, and is asked to provide a textual answer given the new table and the original question.

In step 245, the computer program may provide the output of the LLM to the user.

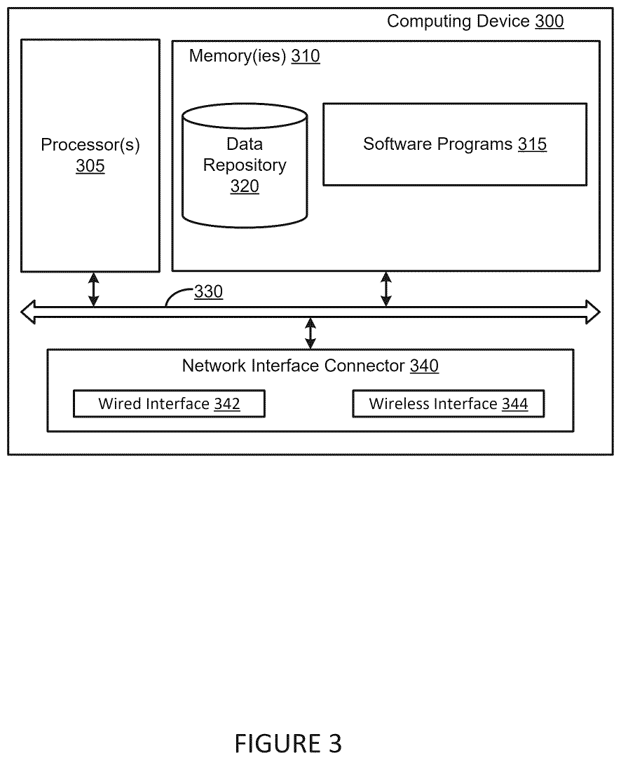

FIG. 3 depicts an exemplary computing system for implementing aspects of the present disclosure. FIG. 3 depicts exemplary computing device 300. Computing device 300 may represent the system components described herein. Computing device 300 may include processor 305 that may be coupled to memory 310. Memory 310 may include volatile memory. Processor 305 may execute computer-executable program code stored in memory 310, such as software programs 315. Software programs 315 may include one or more of the logical steps disclosed herein as a programmatic instruction, which may be executed by processor 305. Memory 310 may also include data repository 320, which may be nonvolatile memory for data persistence. Processor 305 and memory 310 may be coupled by bus 330. Bus 330 may also be coupled to one or more network interface connectors 340, such as wired network interface 342 or wireless network interface 344. Computing device 300 may also have user interface components, such as a screen for displaying graphical user interfaces and receiving input from the user, a mouse, a keyboard and/or other input/output components (not shown).

Hereinafter, general aspects of implementation of the systems and methods of embodiments will be described.

Embodiments of the system or portions of the system may be in the form of a “processing machine,” such as a general-purpose computer, for example. As used herein, the term “processing machine” is to be understood to include at least one processor that uses at least one memory. The at least one memory stores a set of instructions. The instructions may be either permanently or temporarily stored in the memory or memories of the processing machine.

The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

In one embodiment, the processing machine may be a specialized processor.

In one embodiment, the processing machine may be a cloud-based processing machine, a physical processing machine, or combinations thereof.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement embodiments may be a general-purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA (Field-Programmable Gate Array), PLD (Programmable Logic Device), PLA (Programmable Logic Array), or PAL (Programmable Array Logic), or any other device or arrangement of devices that is capable of implementing the steps of the processes disclosed herein.

The processing machine used to implement embodiments may utilize a suitable operating system.

It is appreciated that in order to practice the method of the embodiments as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above, in accordance with a further embodiment, may be performed by a single component. Further, the processing performed by one distinct component as described above may be performed by two distinct components.

In a similar manner, the memory storage performed by two distinct memory portions as described above, in accordance with a further embodiment, may be performed by a single memory portion. Further, the memory storage performed by one distinct memory portion as described above may be performed by two memory portions.

Further, various technologies may be used to provide communication between the various processors and/or memories, as well as to allow the processors and/or the memories to communicate with any other entity; i.e., so as to obtain further instructions or to access and use remote memory stores, for example. Such technologies used to provide such communication might include a network, the Internet, Intranet, Extranet, a LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of embodiments. The set of instructions may be in the form of a program or software. The software may be in the form of system software or application software, for example. The software might also be in the form of a collection of separate programs, a program module within a larger program, or a portion of a program module, for example. The software used might also include modular programming in the form of object-oriented programming. The software tells the processing machine what to do with the data being processed.

Further, it is appreciated that the instructions or set of instructions used in the implementation and operation of embodiments may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments. Also, the instructions and/or data used in the practice of embodiments may utilize any compression or encryption technique or algorithm, as may be desired. An encryption module might be used to encrypt data. Further, files or other data may be decrypted using a suitable decryption module, for example.

As described above, the embodiments may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in embodiments may take on any of a variety of physical forms or transmissions, for example. Illustratively, the medium may be in the form of a compact disc, a DVD, an integrated circuit, a hard disk, a floppy disk, an optical disc, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors.

Further, the memory or memories used in the processing machine that implements embodiments may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the systems and methods, a variety of “user interfaces” may be utilized to allow a user to interface with the processing machine or machines that are used to implement embodiments. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method, it is not necessary that a human user actually interact with a user interface used by the processing machine. Rather, it is also contemplated that the user interface might interact, i.e., convey and receive information, with another processing machine, rather than a human user. Accordingly, the other processing machine might be characterized as a user. Further, it is contemplated that a user interface utilized in the system and method may interact partially with another processing machine or processing machines, while also interacting partially with a human user.

It will be readily understood by those persons skilled in the art that embodiments are susceptible to broad utility and application. Many embodiments and adaptations of the present invention other than those herein described, as well as many variations, modifications and equivalent arrangements, will be apparent from or reasonably suggested by the foregoing description thereof, without departing from the substance or scope.

Accordingly, while the embodiments of the present invention have been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications or equivalent arrangements.

1. A method, comprising:
receiving, by a computer program and from a user electronic device, a user input comprising a user query for dynamic infrastructure data stored in a graph database;
interpreting, by the computer program and using a large language model (LLM), the user query in context of the graph database by replacing text in the user query with graph-specific terminology for the graph database;
identifying, by the computer program and using the LLM, a relevant graph query out of a list of allowed queries for the interpreted user query;
executing, by the computer program, the relevant graph query on the graph database;
transforming, by the computer program, raw output from the graph database into tabular data;
generating, by the computer program and using the LLM, a summary of the tabular data; and
returning, by the computer program, the summary to the user electronic device.

2. The method of claim 1, further comprising:
determining, by the computer program, that the user query comprises a complex request; and
splitting, by the computer program, the complex request into a plurality of simple requests.

3. The method of claim 2, wherein the computer program splits the complex request into the plurality of simple requests by:
prompting the LLM with the complex request and a list of available graph queries to split the complex request into the plurality of simple requests.

4. The method of claim 1, further comprising:
formatting, by the computer program, the user query to a formatting standard.

5. The method of claim 1, wherein the computer program prompts the LLM to replace the text in the user query with the graph-specific terminology.

6. The method of claim 1, wherein the step of identifying the relevant graph query out of the list of allowed queries for the interpreted user query comprises:
prompting, by the computer program, the LLM with the interpreted user query, the list of allowed queries, and expected parameters for those queries to return the relevant query for the interpreted user query.

7. The method of claim 1, wherein the step of transforming the raw output from the graph database into tabular data comprises:
executing, by the computer program, code generated by the LLM to convert a subset of the raw output into tabular data.

8. The method of claim 7, wherein the code comprises table data manipulation functions.

9. The method of claim 7, further comprising:
prompting, by the computer program, the LLM to infer column names for the tabular data from the raw output.

10. The method of claim 1, wherein the step of generating a summary of the tabular data comprises:
prompting, by the computer program, the LLM for the summary by providing the LLM with the tabular data and the user input.

11. A non-transitory computer readable storage medium, including instructions stored thereon, which when read and executed by one or more computer processors, cause the one or more computer processors to perform steps comprising:
receiving, from a user electronic device, a user input comprising a user query for dynamic infrastructure data stored in a graph database;
interpreting, using a large language model (LLM), the user query in context of the graph database by replacing text in the user query with graph-specific terminology for the graph database;
identifying, using the LLM, a relevant graph query out of a list of allowed queries for the interpreted user query;
executing the relevant graph query on the graph database;
transforming raw output from the graph database into tabular data;
generating, using the LLM, a summary of the tabular data; and
returning the summary to the user electronic device.

12. The non-transitory computer readable storage medium of claim 11, further including instructions stored thereon, which when read and executed by the one or more computer processors, cause the one or more computer processors to perform steps comprising:
determining that the user query comprises a complex request; and
splitting the complex request into a plurality of simple requests.

13. The non-transitory computer readable storage medium of claim 12, wherein the step of splitting the user query into a plurality of simple requests comprises:
prompting the LLM with the complex request and a list of available graph queries to split the complex request into the plurality of simple requests.

14. The non-transitory computer readable storage medium of claim 11, further including instructions stored thereon, which when read and executed by the one or more computer processors, cause the one or more computer processors to perform steps comprising:
formatting the user query to a formatting standard.

15. The non-transitory computer readable storage medium of claim 11, wherein the step of the user query in context of the graph database by replacing text in the user query with graph-specific terminology for the graph database comprises:
prompting the LLM replace the text in the user query with the graph-specific terminology.

16. The non-transitory computer readable storage medium of claim 11, wherein the step of identifying the relevant graph query out of the list of allowed queries for the interpreted user query comprises:
prompting the LLM with the interpreted user query, the list of allowed queries, and expected parameters for those queries to return the relevant query for the interpreted user query.

17. The non-transitory computer readable storage medium of claim 11, wherein the step of transforming the raw output from the graph database into tabular data comprises:
executing code generated by the LLM to convert a subset of the raw output into tabular data.

18. The non-transitory computer readable storage medium of claim 17, wherein the code comprises table data manipulation functions.

19. The non-transitory computer readable storage medium of claim 17, further including instructions stored thereon, which when read and executed by the one or more computer processors, cause the one or more computer processors to perform steps comprising:
prompting the LLM to infer column names for the tabular data from the raw output.

20. The non-transitory computer readable storage medium of claim 11, wherein the step of generating a summary of the tabular data comprises: prompting the LLM for the summary by providing the LLM with the tabular data and the user input.
